(19) United States
(12) Patent Application Publication
(10) Pub. No.: US 2007/0033290 A1
(43) Pub. Date: Feb. 8, 2007

(54) Normalization and customization of syndication feeds

(76) Inventors: Joseph Ralph Van Valen III, Sunnyvale, CA (US); Aditya Khosla, Sunnyvale, CA (US); Alberto Cobas, Scotts Valley, CA (US); Edgar Mason Cockrell III, Sterling, VA (US); Colin Chang, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/332,883

(22) Filed: Jan. 17, 2006

Related U.S. Application Data
(63) Continuation-in-part of application No. 11/197,681, filed on Aug. 3, 2005.

(51) Int. Cl. G06F 15/16

(52) U.S. Cl. 709/231; 709/227

(57) ABSTRACT

Systems and methods for normalizing and customizing syndication feeds. The systems and methods include formulating a request for a syndication feed that has been normalized into a particular syndication feed format, sending the request to a server, and receiving a response from the server, where the response includes the normalized syndication feed. The systems and methods also include receiving a request for a syndication feed from a client, determining whether the syndication feed can be obtained from a cache that is accessible to the server, retrieving the syndication feed from the cache if the syndication feed can be obtained from the cache, retrieving the syndication feed from the source of the syndication feed if the syndication feed can not be obtained from the cache, normalizing the syndication feed into a particular syndication feed format, formulating a response that includes the normalized syndication feed, and sending the response to the client.

### CROSS-REFERENCE TO RELATED APPLICATIONS

This application is a continuation-in-part application of U.S. application Ser. No. 11/197,681, filed Aug. 3, 2005, entitled “Enhanced Favorites Service for Web Browsers and Web Applications,” which application is incorporated herein by reference in its entirety.

### BACKGROUND OF THE INVENTION

1. The Field of the Invention

The present invention relates generally to systems and methods for processing and storing syndication feeds. More particularly, embodiments of the invention relate to normalization and customization of syndication feeds.

2. The Relevant Technology

Syndication feeds are increasing in popularity as vehicles for distributing information, particularly information that is changed or added to regularly. Syndication feeds can generally be described as Extensible Markup Language (XML) data files that are formatted using one of a variety of specific syndication feed formats, such as the various versions of Really Simple Syndication (RSS) and Atom. Syndication feeds are offered by many information providers in order to provide syndicated access to a variety of different types of information to users. For example, many news organizations use syndication feeds to syndicate news stories. Likewise, many weblog administrators use syndication feeds to allow easy access to recent weblog updates. Similarly, syndication feeds can be used for other frequently updated statistics such as stock quotes and sports scores.

As syndication feeds have become more popular, several different syndication feed formats have evolved. For example, some common syndication feed formats are RSS versions 0.90, 0.91 Netscape, 0.91 Userland, 0.92, 0.93, 0.94, 1.0 or 2.0, and Atom versions 0.3 or 1.0. Although each syndication feed format generally has common elements, such as a title field (also known as a headline field), a link field, and a description field, each syndication feed format represents said elements differently and also has elements that are not common between the formats. Consequently, there often arises incompatibilities between different syndication feed formats. These differences and incompatibilities between syndication feed formats can make it difficult to design a software application that is capable of receiving as input syndication feeds in more than a single syndication feed format.

Another problem with syndication feeds is user frustration at intermittent unavailability or slow access times to syndication feeds. Popular syndication feeds are often accessed simultaneously and polled frequently by multiple users. A server where a popular syndication feed is hosted can become bogged down with multiple simultaneous requests to access the syndication feed. Similarly, if the server where a syndication feed is hosted goes offline, users will be unable to access the syndication feed during the time that the server is offline.

Another problem with syndication feeds is the difficulty involved in customizing the content of syndication feeds according to the preferences of multiple users. Syndication feeds can contain a variety of different amounts and types of information. For example, a news syndication feed that contains news stories may contain a large number of current news stories. While some users may wish to access all currently available news stories on the news syndication feed, other users, who might be accessing the news syndication feed using a computer with limited resources or a limited screen display, such as a personal digital assistant (PDA), may wish to receive only a limited number of news stories. Likewise, some users may want to gain access to both news story headlines and summaries of the news stories, while other users may only wish to access the news story headlines. The varying preferences of users can make it difficult to design a software application that is capable retrieving syndication feeds that are customized according to the preferences of multiple users.

### BRIEF SUMMARY OF EXEMPLARY EMBODIMENTS OF THE INVENTION

Exemplary embodiments of the present invention relate to systems and methods for normalizing and customizing syndication feeds. The exemplary methods of the present invention generally involve an environment with at least a client and a server, as well as a separate server that hosts a syndication feed.

In one exemplary embodiment, a client formulates a request for a syndication feed that has been normalized into a particular syndication feed format, where the request specifies the source of the syndication feed. Then the client sends the request to a server, where the server is not hosting the syndication feed. Finally, the client receives a response from the server, where the response includes the normalized syndication feed.

In another exemplary embodiment, a server receives a request for a syndication feed from a client, where the request specifies the source of the syndication feed. Next, the server determines whether the syndication feed can be obtained from a cache that is accessible to the server. If the syndication feed can be obtained from the cache, then the server retrieves the syndication feed from the cache. If the syndication feed can not be obtained from the cache, then the server retrieves the syndication feed from the source of the syndication feed. Next, the server normalizes the syndication feed into a particular syndication feed format. Then the server formulates a response that includes the normalized syndication feed. Finally the server sends the response to the client.

In another exemplary embodiment, a server receives a request for a syndication feed from a client, where the request specifies the source of the syndication feed. Next, the server determines whether the syndication feed can be obtained from a cache that is accessible to the server. If the syndication feed can be obtained from the cache, then the server retrieves the syndication feed from the cache. If the syndication feed can not be obtained from the cache, then the server retrieves the syndication feed from the source of the syndication feed. Next, the server customizes the syndication feed according to one or more customization parameters. Then the server formulates a response that includes the customized syndication feed. Finally the server sends the response to the client.

These and other features of the present invention are described in further detail below and in the appended claims, or may be learned by the practice of the invention as set forth hereinafter.

### BRIEF DESCRIPTION OF THE DRAWINGS

To further clarify the above features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a suitable computing system that may implement features of the exemplary embodiments of the present invention;

FIG. 2 illustrates an exemplary network environment for implementing exemplary embodiments of the present invention;

FIG. 3 illustrates an exemplary method for implementing features of the present invention; and

FIG. 4 illustrates another exemplary method for implementing features of the present invention.

FIG. 5 illustrates another exemplary method for implementing features of the present invention.

### DETAILED DESCRIPTION OF EXEMPLARY EMBODIMENTS OF THE INVENTION

Exemplary embodiments of the present invention relate to systems and methods for normalizing and customizing syndication feeds. As used herein, the term “normalizing a syndication feed” is broadly defined as taking a syndication feed in its original syndication feed format and converting the syndication feed into a desired syndication feed format. The definition of the term “normalizing a syndication feed” can also encompass taking a syndication feed in its original format and converting the syndication feed into any number of intermediate formats before finally converting the syndication feed into a desired format. The definition of the term “normalizing a syndication feed” can also encompass taking a syndication feed in an intermediate format and converting the syndication feed into a desired format.

As used herein, the term “customizing a syndication feed” is broadly defined as taking the elements of a syndication feed as they exist at the source of the syndication feed and customizing the elements according to one or more customization parameters. For example, a customization parameter can specify that only the 10 most recent headline elements from the syndication feed are desired. Therefore, “customizing” the syndication feed according to this customization parameter would entail trimming all but the 10 most recent headline elements from the syndication feed. The definition of the term “customizing a syndication feed” can also encompass taking the elements of as they exist at a location other than the source of the syndication feed and customizing the elements according to one or more customization parameters.

1. Exemplary Computing System

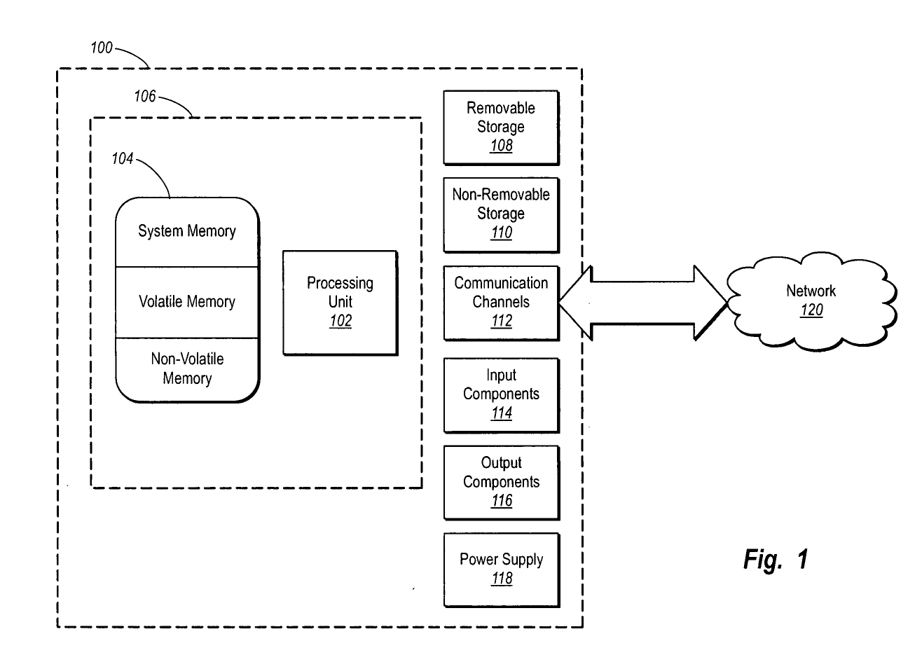

In the description and following claims, the invention is described with reference to acts and symbolic representations of operations that are performed by one or more computers. In the description and following claims, the terms “client” and “server” both refer to a computer. As such, it will be understood that such acts and operations, which are at times referred to as being computer-executed, include the manipulation by the processing unit of the computer of electrical signals representing data in a structured form. This manipulation transforms the data or maintains the data at locations in the memory system of the computer, which reconfigures or otherwise alters the operation of the computer. The data structures where data is maintained are physical locations of the memory that have particular properties defined by the format of the data. However, while the invention is being described in the foregoing context, it is not meant to be limiting and it should be appreciated that several of the acts and operations described hereinafter may also be implemented in hardware. FIG. 1 shows a schematic diagram of an exemplary computer architecture usable for these clients and servers.

For descriptive purposes, the architecture portrayed is only one example of a suitable environment and is not intended to suggest any limitation as to the scope of use or functionality of the invention. Neither should the computing systems be interpreted as having any dependency or requirement relating to any one component or combination of components illustrated in FIG. 1.

Exemplary embodiments of the invention can be practiced with numerous other general-purpose or special-purpose computing or communications environments or configurations. Examples of well known computing systems, environments, and configurations suitable for use with the invention include, but are not limited to, mobile telephones, pocket computers, personal digital assistants, tablet computers, personal computers, servers, transaction terminals, multiprocessor systems, microprocessor-based systems, minicomputers, mainframe computers, and distributed computing environments that include any of the above systems or devices.

In its most basic configuration, a computing system 100 typically includes at least one processing unit 102 and memory 104. The memory 104 may be volatile, such as RAM, non-volatile, such as ROM or flash memory, or some combination of the two. This most basic configuration is illustrated in FIG. 1 by the dashed line 106.

The storage media devices may have additional features and functionality. For example, they may include additional removable and non-removable storage including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer- readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing system.

Within this description and the following claims, the terms “module” or “component” refer to software objects or routines that execute on the computing system. The different components, modules, engines, and services described herein may be implemented as objects or processes that execute on the computing system, for example, as separate threads. While the system and methods described herein are preferably implemented in software, implementations in software and hardware or hardware are also possible and contemplated.

Computing system 100 may also contain communication channels 112 that allow the host to communicate with other systems and devices over, for example, network 120. Communication channels 112 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computing system 100 may also have input components 114 such as a keyboard, mouse, pen, voice-input component, touch-input device, and so forth. Output components 116 include screen displays, speakers, printer, etc., and rendering modules (often called “adapters”) for driving them. The computing system 100 has a power supply 118. All these components are well known in the art and need not be discussed at length here.

2. Exemplary Network System

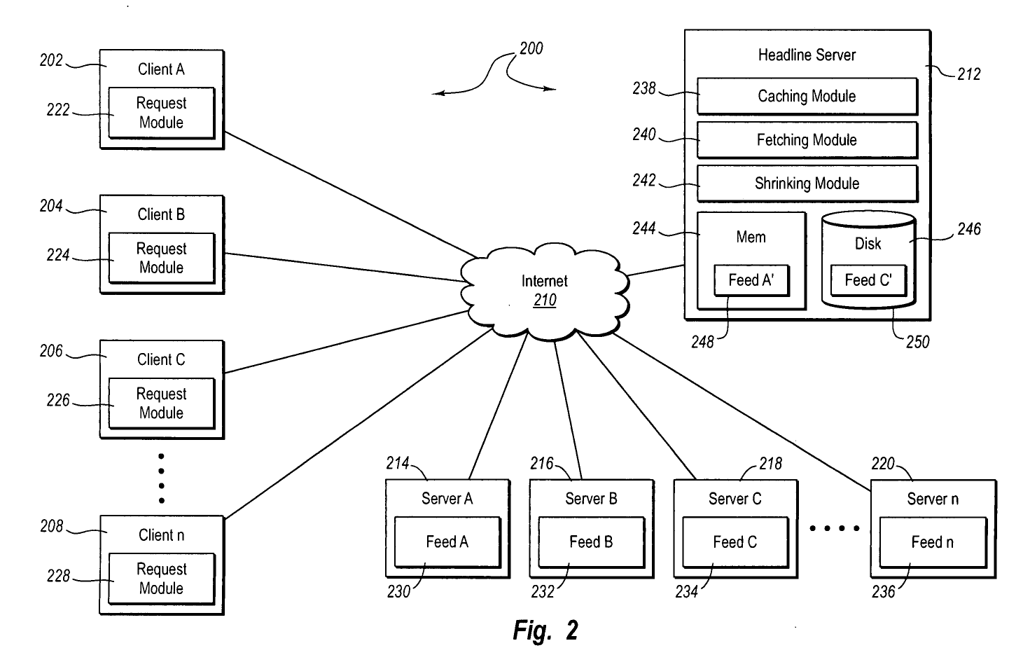

Turning to FIG. 2, an exemplary network system 200 is illustrated in which normalized and/or customized syndication feeds can be sent and received. System 200 includes client computer systems Client A 202, Client B 204, and Client C 206. System 200 can also include up to “n” client computer systems, represented in FIG. 2 by Client n 208. Each client computer system in System 200 is capable of establishing a network connection over Internet 210 with Headline Server 212. System 200 also includes server computer systems Server A 214, Server B 216, and Server C 218. System 200 can also include up to “n” server computer systems, represented in FIG. 2 by Server n 220. Each server computer system in System 200 can also be accessed by each client computer system or by Headline Server 212 over Internet 210. Each server computer system in System 200 can alternatively be accessed by each client computer system in System 200 over another wired or wireless network.

Each client computer system in System 200 includes a request module. Client A 202 includes Request Module 222, Client B 204 includes Request Module 224, Client C 206 includes Request Module 226, and Client n 208 includes Request Module 228. Each request module is configured to formulate requests for syndication feeds. These requests can then be sent over Internet 210 to any of the server computer systems in System 200, including Headline Server 212. Requests sent to computer systems in System 200 other than Headline Server 212 can be formulated as basic HTTP requests. Requests sent to Headline Server 212 can be formulated in a standard markup language including, but not limited to, Extensible Markup Language (XML) or Dynamic HyperText Markup Language (DHTML). Also, since requests for normalized and/or customized syndication feeds are formulated in a standard markup language, such as XML or DHTML, software applications running on any of the client computer systems in System 200 can formulate a request for a syndication feed as long as the applications are capable of outputting a request in the standard markup language. Although XML and DHTML are given as examples of standard markup languages in which a request can be formulated, another standard markup language could be substituted in place of XML or DHTML in the requests formulated in System 200.

Requests will generally specify the source of the syndication feed. The source of the syndication feed can be the Uniform Resource Locator (URL) of the syndication feed. For example, the physical file for a certain syndication feed might be named “examplefeed.xml” and might be located in the root directory of “www.example.com”. If a user wants to request this particular syndication feed, the user can specify in the request that the source of the desired syndication feed is “http://www.example.com/examplefeed.xml”. Alternatively, the source of one or more syndication feeds can be specified as a root URL or domain name. For example, “www.example.com” might contain one or more syndication feeds. If a user wants to request any syndication feeds located on “www.example.com”, the user can specify in the request that the source of the one or more syndication feeds is “www.example.com”. In this example, Headline Server 212 will check accessible caches and/or crawl “www.example.com” in order to determine if “www.example.com” contains any syndication feeds.

The request can also specify the particular syndication feed format that the syndication feed should be normalized into. For example, a request might specify that the syndication feed in the response should be formatted in RSS version 2.0. Likewise, another request might specify that the syndication feed in the response should be formatted in Atom version 1.0.

The request can also include one or more customization parameters that specify how the syndication feed in the response should be customized. These customization parameters can include, for example, a parameter specifying the number of titles (also called headlines) to be retrieved from the syndication feed, a parameter specifying how recent the headlines must be in order to be included in the syndication feed, and a parameter specifying the type of HTML tags that can be included in the description field of the syndication feed (also called a description filter). These customization parameters can also include an optional key parameter that uniquely identifies each request for a syndication feed and that will be returned with the corresponding response. Also, a single request can include requests for more than one syndication feed simultaneously.

Each of Server A 214, Server B 216, Server C 218, and Server n 220 hosts a syndication feed. Server A 214 hosts a Feed A 230, Server B 216 hosts a Feed B 232, Server C 218 hosts a Feed C 234, and Server n 220 hosts a Feed n 236. Each hosted syndication feed in System 200 can be formatted in a distinct syndication feed format. For example, Feed A 230 can be formatted in RSS versions 0.90, Feed B 232 can be formatted in RSS version 0.94, Feed C 234 in RSS version 1.0, and Feed n 238 in Atom version 1.0. Therefore, a software application running on a client computer system that accesses more than one syndication feed in System 200 must be capable of handling any differences or incompatibilities between the distinct formats of the syndication feeds. To avoid the difficulty involved in designing software applications that are capable of handling differences or incompatibilities between distinct syndication feed formats, the request modules of the client computer systems in System 200 can instead be configured to request syndication feeds from Headline Server 212. Headline Server 212 will respond to these requests by retrieving the syndication feeds and normalizing the syndication feeds into whatever format for which the request modules are configured.

Headline Server 212 is configured to handle requests for normalized syndication feeds from client computer systems. As defined above, a normalized syndication feed is a syndication feed that has been converted from its original syndication feed format into a syndication feed format required by the requesting user or requesting application. For example, suppose Request Module 226 on Client C 206 can be designed to handle only RSS version 2.0 syndication feeds. Therefore, if Feed B 232 hosted on Server B 216 were to be normalized for Request Module 226, Feed B 232 would have to be converted from its original syndication feed format, RSS version 0.94, to a normalized syndication feed format that can be handled by Request Module 226, RSS version 2.0. In one exemplary embodiment, this normalization is accomplished on Headline Server 212 by first converting each syndication feed into a generic object format which leverages the Java ROME library. Then, each syndication feed is then converted from the generic object format into the normalized syndication feed format. In one embodiment, Headline Server 212 can be an Apache Tomcat based server.

Headline Server 212 includes a Caching Module 238, a Fetching Module 240, a Shrinking Module 242, a Memory Cache 244, and a Disk Cache 246. Caching Module 238 is used to check Memory Cache 244 and Disk Cache 246 for copies of requested syndication feeds and retrieve copies of requested syndication feeds that are located in either cache. A copy of a syndication feed can be stored in Memory Cache 244 or Disk Cache 246 in the generic object format described above. Alternatively, a copy of a syndication feed can be stored in Memory Cache 244 or Disk Cache 246 in the original syndication feed format or a normalized syndication feed format. As illustrated, Memory Cache 244 includes Feed A′ 248, which represents a copy of Feed A that is stored in Memory Cache 244 in the original format of Feed A 230, in an intermediate format such as a generic object format, or in a normalized format.

Caching Module 238 is also used to place syndication feeds in Memory Cache 242, and transfer syndication feeds from Memory Cache 244 to Disk Cache 246 after a specific time has lapsed since the syndication feeds were accessed, for example, after thirty minutes. As illustrated, Disk Cache 246 includes Feed C′ 250, which represents a copy of Feed C that is stored in Disk Cache 246 in the original format of Feed C 234, in an intermediate format such as the generic object format described above, or in a normalized format. Caching module 238 is also used to delete syndication feeds from Disk Cache after a specific time has lapsed since the syndication feeds were accessed, for example, two days. Fetching Module 240 is used to retrieve syndication feeds from the sources of the syndication feeds where the requested syndication feeds can not be obtained from either Memory Cache 244 or Disk Cache 246. Fetching Module 240 can maintain a pool of HTTP request objects that can go out to multiple sources simultaneously to retrieve syndication feeds. Shrinking Module 242 is used to optimize data to be stored on either Memory Cache 244 or Disk Cache 246, reformat or compress the data in an optimal manner for either Memory Cache 244 or Disk Cache 246, and transfer syndication feeds between Memory Cache 244 and Disk Cache 246 as needed to reduce access time for frequently requested syndication feeds.

In System 200, Headline Server 212 has two caches that it can access: Memory Cache 244 and Disk Cache 246. Syndication feeds are stored in Memory Cache 244 or Disk Cache 246 in the initial, intermediate, or normalized format described above. Syndication feeds stored in Memory Cache 244 can be accessed much faster than syndication feeds stored in Disk Cache 246. However, Disk Cache 246 is capable of storing much more data than Memory Cache 244. In other words, Memory Cache 244 is faster than Disk Cache 246, but Disk Cache 246 is larger than Memory Cache 244. Generally, Memory Cache 244 will contain the most recent and more frequently accessed syndication feeds and Disk cache 246 will contain the older and less often accessed syndication feeds. Also, a predetermined number of headlines, for example ten, for each syndication feed are stored in Memory Cache 244 and Disk Cache 246. Therefore, even if less than ten headlines are requested in a particular request, if the requested syndication feed is retrieved from its source, ten headlines will be retrieved and cached in Memory Cache 244 or Disk Cache 246. This predetermined number of headlines can be whatever is considered to be sufficient for a majority of requests that are received by Headline Server 212 for all syndication feeds or for a given syndication feed.

3. Exemplary Method for Requesting a Syndication Feed

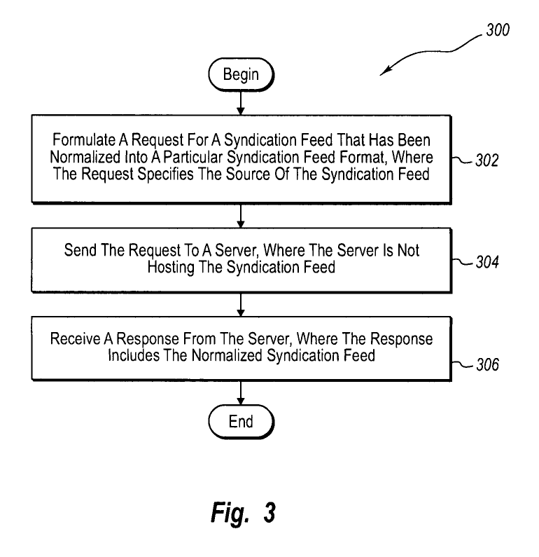

FIG. 3 illustrates an exemplary method 300 for implementing certain stages and features of the present invention. Those of skill in the art will appreciate that other stages or features can be added, certain stages can be eliminated, or the stages can be rearranged in a different order. In one embodiment, as illustrated in FIG. 3, at 302, a client formulates a request for a syndication feed that has been normalized into a particular syndication feed format, where the request specifies the source of the syndication feed. Next, at 304, the client sends the request to a server, where the server is not hosting the syndication feed. Finally at 306, the client receives a response from the server, where the response includes the normalized syndication feed.

following example will illustrate method 300 of FIG. 3 by making reference to System 200 of FIG. 2. The example illustrates how a syndication feed can be requested, normalized, and received by a client computer system in System 200. In this example, Request Module 224 on Client B 204 is only designed to receive as input syndication feeds in RSS version 2.0. Therefore, if Request Module 224 requires as input Feed A 230 that is hosted on Server A 214 and Feed C 234 that is hosted on Server C 218, Request Module 224 can not request Feed A 230 and Feed C 234 directly from their respective host servers because, as discussed above, Feed A 230 is an RSS version 0.90 syndication feed and Feed C 234 is an RSS version 1.0 syndication feed.

In order to avoid any incompatibilities between syndication feed formats RSS version 2.0 and RSS versions 0.90 or 1.0, instead of requesting the syndication feeds directly from Server A 214 and Server C 218, respectively, Request Module 224 can request a normalized copy of Feed A and a normalized copy of Feed C from Headline Server 212. In one exemplary embodiment, Headline Server 212 is preconfigured to normalize all requested feed into RSS version 2.0. Thus, the syndication feed format into which all syndication feeds will be normalized can be determined on Headline Server 212 before any request is received from Request Module 224. In another exemplary embodiment, the request formulated by Request Module 224 can specify the particular syndication feed format into which each requested syndication feed should be normalized.

Continuing with the example, at 302, Request Module 224 formulates a request in XML for a normalized Feed A and a normalized Feed C. The XML request can be formulated as follows:

.
.
.

| | |
|---|---|
| [01] | <Request> |

| [02] | <Request1 |
|---|---|
| | Url=“http://www.exampleA.com/rss/exampleA_rss.xml” |

| [03] | TimeStamp=“2005-10-26T21:45:00”> |
|---|---|
| [04] | <Options NumHeadlines=“30” |
| | DescriptionFilter=“strict”/> |

| [05] | </Request1> |
|---|---|
| [06] | <Request2 |
| | Url=“http://www.exampleC.org/rss/exampleC.xml” |

| | |
|---|---|
| [07] | TimeStamp=“2005-06-15T11:30:00”> |
| [08] | <Options NumHeadlines=“5” DescriptionFilter=“off”/> |

| | |
|---|---|
| [09] | </Request2> |

| | |
|---|---|
| [10] | </Request> |
| . | |
| . | |
| . | |

Shown at line 01 of the XML request is an opening tag that corresponds to a closing tag at line 10. Accordingly, lines 01 through 10 define an element entitled “Request”. Subelements of the Request element are presented at lines 02 through 09. In this XML request, the Request element indicates that the subelements and attributes at lines 02 through 09 are associated with a request to Headline Server 112 for one or more normalized syndication feeds.

Shown at line 02 of the XML request is an opening tag that corresponds to a closing tag at line 05. Accordingly, lines 02 through 05 define an element entitled “Request1”. A single subelement of the Request1 element is presented at lines 04. In this XML request, the Request1 element at line 02 is associated with a request to Headline Server 112 for Feed A.

The first attribute of the Request1 element at line 02 is entitled “Url”. The required Url attribute specifies the URL of the syndication feed, which is one way of designating the source of the syndication feed, and must be included as an attribute of each request element. In this example request, the URL in the request for Feed A is “http://www.exampleA.com/rss/exampleA_rss.xml”. This URL can be used to locate Server A 214, where Feed A 230 is being hosted, over Internet 210.

The second attribute of the Request1 element at line 02 is shown at line 03 and entitled “TimeStamp”. The optional TimeStamp attribute specifies an exact date/time, in “xsd:dateTime” format, against which to compare the syndication feed data so that only data that is more recent than the data/time specified in the TimeStamp attribute is retrieved. If the optional TimeStamp attribute is missing in a request, it indicates that syndication feed has never been accessed by the user for whom the syndication feed is being requested. If the optional TimeStamp attribute is present, the value of the TimeStamp attribute will correlate with the last time that the syndication feed was accessed by the user for whom the syndication feed is being requested. In this example, the TimeStamp in the request for Feed A is “2005-10-26T21:45:00”, which means that the last time that Request Module 224 accessed Feed A on behalf of the current user was at 9:45 p.m. on Oct. 26, 2005.

The only subelement of the Request1 element at line 02 is shown at line 04 and entitled “Options”. The first attribute of the Options element at line 04 is entitled “NumHeadlines”. The NumHeadlines attribute specifies the maximum number of headlines to retrieve from the syndication feed being requested. If the NumHeadlines attribute is missing, a default number of headlines, such as ten, will be retrieved. In this example, the NumHeadlines for Feed A is “30”, which means that Request Module 224 requires that a maximum of thirty headlines be retrieved from Feed A. The second attribute of the Options element at line 04 is entitled “DescriptionFilter”. The DescriptionFilter attribute specifies the type of HTML tags to retrieve in the description field of each headline retrieved from the syndication feed. The possible values of this attribute are “strict”, “loose”, and “off”: “off” disables this feature, while “strict” and “loose” define two whitelists of HTML tags that are allowed in the description field. The “strict” whitelist contains only minor formatting tags, and the “loose” whitelist adds non-formatting tags such as links and images. In this exemplary request, the DescriptionFilter for Feed A is “strict”, which means that Request Module 224 requires that only minor formatting tags be retrieved in the description field of each headline retrieved from Feed A.

Shown at line 06 of the XML request is an opening tag that corresponds to a closing tag at line 09. Accordingly, lines 06 through 09 define a “Request2” element. A single subelement of the Request2 element is presented at line 08, and is essentially identical to the subelement of the Request1 element shown at line 02, except that the values of the subelements are different between the Request1 and Request2 elements. In this example, the Request2 element at line 06 corresponds to Feed C. The URL for Feed C 234, listed at line 06, is “http://www.exampleC.org/rssexampleC.xml”. The TimeStamp for Feed C, listed at line 07, is “2005-06-15T1 1:30:00”, which means that the last time that Request Module 224 accessed Feed C on behalf of the current user was at 11:30 a.m. on Jun. 15, 2005. The NumHeadlines for Feed C, listed at line 08, is “5”, which mean that Request Module 224 requires that a maximum of five headlines be retrieved from Feed C. The DescriptionFilter for Feed C, also listed at line 08, is “off”, which means that Request Module 224 requires the description field of each headline retrieved from Feed C to be unaltered.

Continuing with the example, once the request for normalized syndication feeds has been formulated by Request Module 224 at 302, the request is then sent by Request Module 224 to Headline Server 212 over Internet 210 at 304. In other words, instead of sending requests for Feed A and Feed C directly to Server A 214 and Server C 218, respectively, the request formulated at 302 is sent at 304 to Headline Server 212. After Headline Server 212 retrieves copies of Feed A and Feed C, either from Memory Cache 244, Disk Cache 246, or directly from Server A 214 and Server C 218, respectively, Headline Server 212 normalizes the copies of Feed A′ 248 and Feed C′ 250 into, for example, RSS version 2.0.

Headline Server 212 also customizes the normalized copies of Feed A′ 248 and Feed C′ 250 according to the customization parameters specified in the XML request above. Accordingly, in customizing the normalized copy of Feed A′ 248, Headline Server 212 includes a maximum of 30 headlines, each of which must be more recent than 9:45 p.m. on Oct. 26, 2005, and strips all but minor HTML formatting tags out of the description field of each headline. Likewise, in formatting the normalized copy of Feed C′ 250, Headline Server includes a maximum of 5 headlines, each of which is more recent than 11:30 a.m. on Jun. 15, 2005.

After normalizing and customizing the copies of Feed A′ 248 and Feed C′ 250, Headline Server 212 formulates a response that includes the normalized and customized copies of Feed A′ 248 and Feed C′ 250 and sends the response to Request Module 224. At 306, Request Module 224 receives the response from Headline Server 212, and thus receives copies of Feed A′ 248 and Feed C′ 250 that have been normalized in RSS version 2.0 even though the original syndication feed formats of Feed A 230 and Feed C 234 were RSS versions 0.90 and 1.0, respectively. Since Request Module 224 in this example is only designed to handle syndication feeds formatted in RSS version 2.0, the functionality of Headline Server 212 enables Request Module 224 to utilize syndication feeds it otherwise would be unable to utilize.

4. Exemplary Method for Responding to a Request for a Syndication Feed

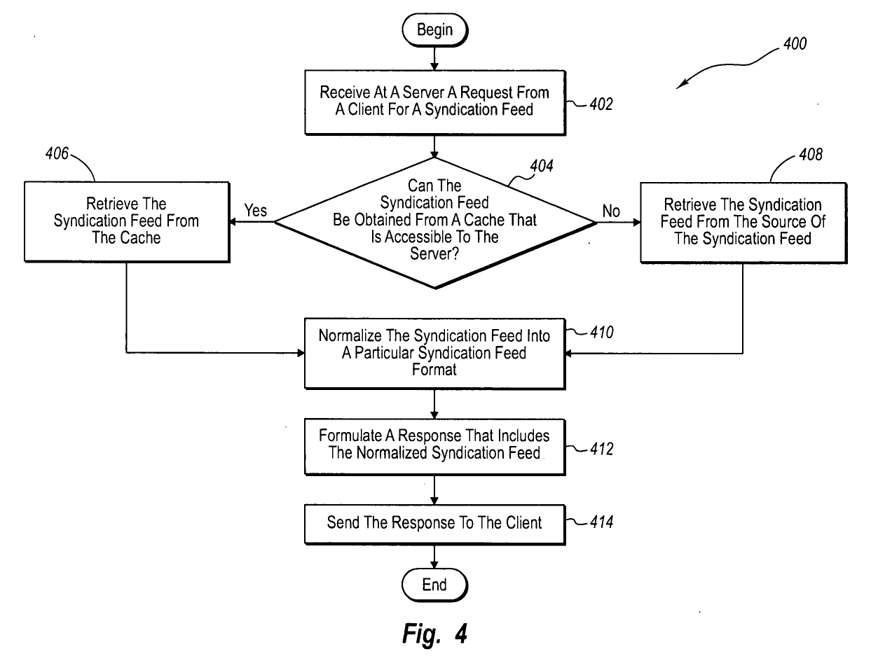

FIG. 4 illustrates an exemplary method 400 for implementing certain stages and features of the present invention. Those of skill in the art will appreciate that other stages or features can be added, certain stages can be eliminated, or the stages can be rearranged in a different order. In one embodiment, as illustrated in FIG. 4, at 402, a server receives a request for a syndication feed from a client, where the request specifies the source of the syndication feed. Next, at 404, the server determines whether the syndication feed can be obtained from a cache that is accessible to the server. If the syndication feed can be obtained from the cache, the server proceeds to 406 where the server retrieves the syndication feed from the cache. Alternatively, if the syndication feed can not be obtained from the cache, the server instead proceeds to 408 where the server retrieves the syndication feed from the source of the syndication feed specified in the request. Next, at 410, the server normalizes the syndication feed into a particular syndication feed format. Then, at 412, the server formulates a response that includes the normalized syndication feed. Finally, at 414, the server sends the response to the client.

Continuing with the example discussed above, the following will illustrate method 400 of FIG. 4 by making reference to System 200 of FIG. 2. The example illustrates how the example XML request for a normalized syndication feed, discussed above in connection with FIG. 3, can be fulfilled in System 200. As discussed above, the example XML request is sent to Headline Server 212 by Request Module 224. The example XML request includes requests for two separate syndication feeds, Feed A and Feed C. As discussed above, the example XML request specifies a source URL for each of Feed A and Feed C. Although the following description will discuss the actions taken by Headline Server 212 with respect to fulfilling the requests for Feed A and Feed C separately, Headline Server 212 can handle the request for each simultaneously, for example, by spawning a separate thread for each separate syndication feed requested.

At 402, Headline Server 212 receives the XML request for Feed A and Feed C from Request Module 224. At 404, Caching Module 238 of Headline Server 212 first determines whether Feed A can be obtained from a cache that is accessible to Headline Server 212. As discussed above, Headline Server 212 can access two caches: Memory Cache 244 and Disk Cache 246. Since Memory Cache 244 is faster than Disk Cache 246, Caching Module 238 will first check Memory Cache 244 for the requested syndication feed.

If Feed A was requested of Headline Server 212 recently, either by Request Module 224 or by another request module, Caching Module 238 will have placed a copy of Feed A in Memory Cache 244. However, if Feed A has never been requested of Headline Server 212, or if Feed A had not been requested of Headline Server 212 recently, then Feed A will not be found in Memory Cache 244. As illustrated in FIG. 1, Memory Cache 244 includes Feed A′ 248, which represents a copy of Feed A that is stored in Memory Cache 244.

However, even if at 404 Caching Module 238 does locate Feed A in Memory Cache 244, where the request for Feed A includes customization parameters, as it does in this case, then Caching Module 238 must further determine whether the copy of Feed A′ 248 stored in Memory Cache 244 is capable of being customized according to the customization parameters specified in the request. As discussed above, one of the customization parameters in the request for Feed A is a NumHeadlines parameter that specifies that a maximum of thirty headlines should be retrieved from Feed A. Even if Caching Module 238 does locate a copy of Feed A′ 248 in Memory Cache 244, if the copy does not contain at least thirty headlines, then the copy is not capable of being customized according to the NumHeadlines parameter in the request. In other words, if Feed A′ 248 illustrated in FIG. 1 is not capable of being customized according to the NumHeadlines parameter in the request, then a suitable copy of Feed A can not be obtained from Memory Cache 244.

Therefore, where the request for a feed specifies customization parameters, the Memory Cache 244 must be checked by Caching Module 238 both for the presence of the feed as well as the capability of the feed for being customized according to the customization parameters specified in the request. If at 404 Caching Module 238 finds a suitable copy of Feed A in Memory Cache 244 or Disk Cache 246, such as Feed A′ 248, then method 400 proceeds to 406 where Caching Module 238 retrieves Feed A′ 248 from Memory Cache 244.

If, on the other hand, Caching Module 238 does not find a copy of Feed A in Memory Cache 244, Caching Module 238 will next check Disk Cache 246 for a suitable copy of Feed A. As it did with Memory Cache 244, Caching Module 238 will check Disk Cache 246 for both the presence of a copy of Feed A and the capability of a located copy of Feed A to be customized according to the customization parameters specified in the request. If at 404 Caching Module 238 finds a suitable copy of Feed A in Disk Cache 246, method 400 proceeds to 406 where Caching Module 238 retrieves Feed A from Disk Cache 246.

If, however, at 404 Caching Module 238 does not find a suitable copy of Feed A in either Memory Cache 244 or Disk Cache 246, then method 400 proceeds instead to 408 where Fetching Module 240 will attempt to go to the source of Feed A that is specified in the request in order to retrieve a copy of Feed A. The request specified that the source of Feed A is the URL “http://www.exampleA.com/rss/exampleA_rss.xml”. Therefore, Fetching Module 240 will attempt to access “http://www.exampleA.com/rss/exampleA_rss.xml” over Internet 210 in order to obtain a copy of Feed A 230. This request from Fetching Module 240 will be directed toward Server A 214. Immediately after Fetching Module 240 retrieves any syndication feed from its source, the syndication feed will be placed in Memory Cache 244. Therefore, after Fetching Module 240 retrieves a copy of Feed A 230 from Server A 214, a copy of Feed A′ 248 will be placed in Memory Cache 244. This will enable quicker retrieval of Feed A′ 248 in the future since it is much quicker for Headline Server 212 to retrieve a syndication feed from memory Cache 244 than it is to obtain the syndication feed from its source. Likewise, where a syndication feed is cached, the syndication feed will be accessible a to Headline Server 212, and consequently to any clients accessing Headline Server 212, even when the server hosting the syndication feed is offline. Where a copy of Feed A′ 248 is already located in Memory Cache 244, as illustrated in FIG. 2 by Feed A′ 248, the copy of Feed A′ 248 will be replaced with the most recent copy of Feed A 230 that was retrieved from Server A 214.

After a copy of Feed A has been retrieved either from Memory Cache 244, Disk Cache 246, or Server A 214 at either 406 or 408, method 400 proceeds to 410 where Headline Server 212 will normalize the copy of Feed A′ 248 from RSS version 0.90 to RSS version 2.0. As discussed above, the target syndication feed format can either be preconfigured on Headline Server 212, or can be specified in the request. In this case, RSS version 2.0 is preconfigured as the syndication feed format into which all syndication feeds will be normalized on Headline Server 212.

Where the request contains customization parameters, as it does in this case, Headline Server 212 will also customize the normalized copy of the syndication feed according to the customization parameters specified in the request. As discussed above, one customization parameter in the request for Feed A specified that Feed A should include a maximum of thirty headlines. Therefore, if the normalized copy of Feed A′ 248 contains more than thirty headlines, all but the most recent thirty headlines will be stripped away by Headline Server 212. Another customization parameter in the request for Feed A specified that only headlines more recent than 9:45 p.m. on Oct. 26, 2005 should be retrieved. Therefore, if the normalized copy of Feed A′ 248 contains any headlines that are not more recent than 9:45 p.m. on Oct. 26, 2005, all but the headlines that are more recent than 9:45 p.m. on Oct. 26, 2005 will be stripped away. A final customization parameter in the request for Feed A specified that only minor HTML formatting tags be retrieved in the description field of each headline retrieved from Feed A. Therefore, any HTML formatting tags in description field of each headline in the normalized copy of Feed A′ 248 that are not minor HTML tags will be stripped away.

Headline Server 212 will also perform similar functions for the request for Feed C as it did for the request for Feed A. Specifically, each of 404, 406 or 408, 410, and 412 will be carried out for the request for Feed C according to the parameters of the request for Feed C. During 406, the copy of Feed C′ 250 located in Disk Cache 246 will be analyzed to determine if Feed C′ 250 is suitable given the customization parameters specified in the request. If Feed C′ 250 is suitable, Feed C′ 250 will be normalized and customized according to the request. The copy of Feed C′ 250 will be moved from Disk Cache 246 to Memory Cache 244.

If Feed C′ 250 is not suitable, at 408 Fetching Module 240 will attempt to go to the source of Feed C that is specified in the request in order to retrieve a copy of Feed C. The request specified that the source of Feed C is the URL “http://www.exampleC.org/rssexampleC.xml”. Therefore, Fetching Module 240 will attempt to access “http://www.exampleC.org/rssexampleC.xml” over Internet 210 in order to obtain a copy of Feed C 234. This request from Fetching Module 240 will be directed toward Server C 218. Immediately after Fetching Module 240 retrieves a copy of Feed C 234 from its source, a copy Feed C will be placed in Memory Cache 244. Where a copy of Feed C′ 250 is already located in Disk Cache 246, the copy of Feed C′ 250 will be deleted from Disk Cache 246 and the retrieved copy of Feed C placed in Memory Cache 244.

Finally, after normalization and requested customization to the copies of Feed A′ 248 and Feed C′ 250, at 412 Headline Server 212 will formulate a response that includes the normalized and customized copies of Feed A′ 248 and Feed C′ 250. The response can be formulated by Headline Server 212 as XML as follows:

.
.
.

| | |
|---|---|
| [01] | <Response> |

| [02] | <Response1 |
|---|---|
| | url=“http://www.exampleA.com/rss/exampleA_rss.xml”> |

| | |
|---|---|
| [03] | <ResponseCode Status=“success”/> |
| [04] | <rss version=“2.0”> |

| | |
|---|---|
| [05] | <[placeholder]> |

| | |
|---|---|
| [06] | </rss> |

| [07] | </Response1> |
|---|---|
| [08] | <Response2 |
| | url=“http://www.exampleC.org/rss/exampleC.xml”>> |

| | |
|---|---|
| [09] | <ResponseCode Status=“success”/> |
| [10] | <rss version=“2.0”> |

| | |
|---|---|
| [11] | <[placeholder]> |

| | |
|---|---|
| [12] | </rss> |

| | |
|---|---|
| [13] | </Response2> |

| | |
|---|---|
| [14] | </Response> |
| . | |
| . | |
| . | |

Shown at line 01 of the XML response is an opening tag that corresponds to a closing tag at line 14. Accordingly, lines 01 through 14 define an element entitled “Response”. Subelements of the Response element are presented at lines 02 through 13. In this XML response, the Response is associated with a response from Headline Server 112 to a request for Feed A and Feed C.

Shown at line 02 of the XML request is an opening tag that corresponds to a closing tag at line 07. Accordingly, lines 02 through 07 define an element entitled “Response1”. Subelements of the Response1 element are presented at lines 03 through 06. In this XML response, the Response1 element is associated with a response from Headline Server 112-to a request for a normalized Feed A 230. The Response1 element at line 02 has an associated “curl” characteristic with a value of “http://www.exampleA.com/rss/exampleA_rss.xml”. This url characteristic specifies the source of Feed A, which is specified in this case using the URL for Feed A.

The first subelement of the Response1 element at line 02 is shown at line 03 and entitled “ResponseCode”. The single attribute of the ResponseCode element is entitled “Status”. The Status attribute specifies the status of the attempt to retrieve and normalize and customize the requested syndication feed. In this example response, the Status for the response to the request for Feed A is “success”, which indicates that the attempt to retrieve and normalize and customize Feed A was successful.

The second subelement of the Response1 element at line 02 is shown at lines 04 to 06 and consists of the normalized Feed A′ 248. As can be seen from the “version” attribute of the “rss” element at line 04, Feed A′ 248 has been normalized into RSS version 2.0. As a subelement of the rss element at line 04, a placeholder has been left at line 05 where the actual normalized syndication feed headlines and associated data will be included in the response.

Shown at line 08 of the XML response is a “Response2” element corresponding to Feed C. The format of the Response2 element is similar to the Response1 element, with a Status of “success”, and the syndication feed headlines and data for Feed C normalized into RSS version 2.0.

After the response discussed above has been formulated at 412 by Headline Server 212, at 414, Headline Server 212 will send the response to Request Module 224. Request Module 224 will thus receive normalized and customized copies of Feed A′ 248 and Feed C′ 250 from Headline Server 212.

5. Exemplary Method for Responding to a Request for Customized Syndication Feed

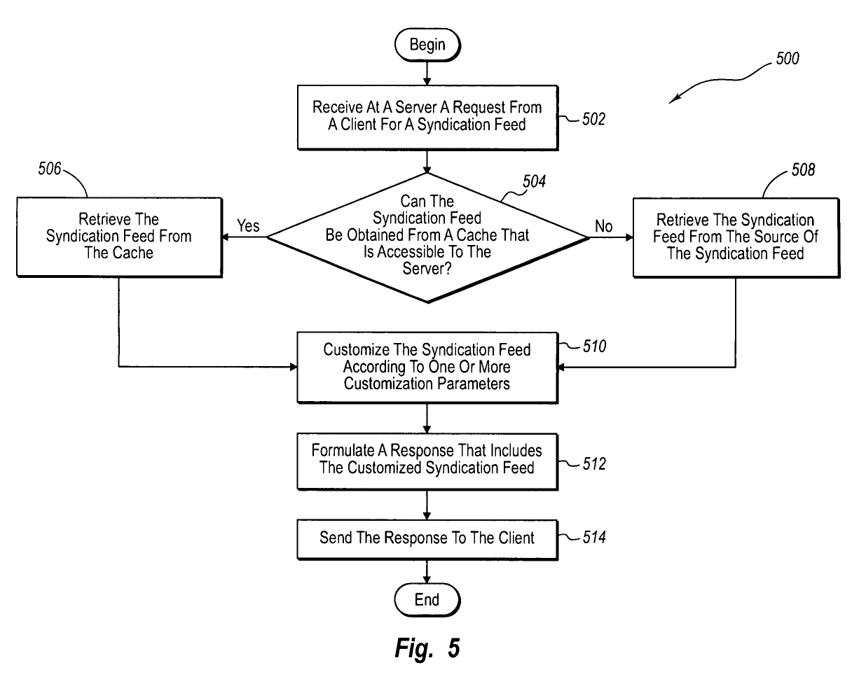

FIG. 5 illustrates another exemplary method 500 for implementing certain stages and features of the present invention. Those of skill in the art will appreciate that other stages or features can be added, certain stages can be eliminated, or the stages can be rearranged in a different order. In one embodiment, as illustrated in FIG. 5, at 502, a server receives a request for a syndication feed from a client, where the request specifies the source of the syndication feed. Next, at 504, the server determines whether the syndication feed can be obtained from a cache that is accessible to the server. If the syndication feed can be obtained from the cache, the server proceeds to 506 where the server retrieves the syndication feed from the cache. Alternatively, if the syndication feed can not be obtained from the cache, the server instead proceeds to 508 where the server retrieves the syndication feed from the source of the syndication feed specified in the request. Next, at 510, the server customizes the syndication feed according to one or more customization parameters. Then, at 512, the server formulates a response that includes the customized syndication feed. Finally, at 514, the server sends the response to the client.

Method 500 of FIG. 5 can be implemented in connection with System 200 of FIG. 2 in similar fashion as method 400 of FIG. 4, as discussed above. As discussed in connection with method 400, the one or more customization parameters of method 500 can be specified in the request for the syndication feed at 502. One additional feature of method 500 not discussed above in connection with method 400, however, is that the one or more customization parameters can be determined on Headline Server 212 before the request is received from the client at 502, instead of the request specifying the one or more customization parameter at 502. Thus, Headline Server 212 can be preconfigured to customize particular elements of a requested syndication feed for a particular client or for all clients.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system including at least a server and a client, a method for the client to receive a normalized syndication feed from the server, the method comprising:
formulating a request for a syndication feed that has been normalized into a particular syndication feed format, where the request specifies the source of the syndication feed;
sending the request to the server, where the server is not hosting the syndication feed; and
receiving a response from the server, where the response includes the normalized syndication feed.

2. The method as recited in claim 1, wherein formulating a request for a syndication feed that has been normalized into a particular syndication feed format further comprises specifying the particular syndication feed format.

3. The method as recited in claim 1, wherein the particular syndication feed format is at least one of RSS version 0.90, RSS version 0.91 Netscape, RSS version 0.91 Userland, RSS version 0.92, RSS version 0.93, RSS version 0.94, RSS version 1.0, RSS version 2.0, Atom version 0.3, or Atom version 1.0.

4. The method as recited in claim 1, wherein formulating a request for a syndication feed that has been normalized into a particular syndication feed format further comprises formatting the request in XML or DHTML.

5. The method as recited in claim 1, wherein the source of the syndication feed specified in the request comprises at least one of the URL of the syndication feed or a domain name where one or more syndication feeds are accessible.

6. The method as recited in claim 1, wherein formulating a request for a syndication feed that has been normalized into a particular syndication feed format further comprises specifying one or more customization parameters.

7. The method as recited in claim 6, wherein the one or more customization parameters include at least one of:
a parameter specifying the number of headlines to be included in the syndication feed;
a parameter specifying how recent the headlines must be in order to be included in the syndication feed; or
a parameter specifying the type of html tags that can be included in the description field of the syndication feed.

8. The method as recited in claim 6, where the syndication feed that has been normalized into a particular syndication feed format by the server has further been customized by the server according to the one or more customization parameters specified in the request.

9. In a system including at least a server and a client, a method for the server to send a normalized syndication feed to the client, the method comprising:
receiving a request for a syndication feed from the client, wherein the request specifies the source of the syndication feed;
determining whether the syndication feed can be obtained from a cache that is accessible to the server;
retrieving the syndication feed from the cache if the syndication feed can be obtained from the cache;
retrieving the syndication feed from the source of the syndication feed if the syndication feed can not be obtained from the cache;
normalizing the syndication feed into a particular syndication feed format;
formulating a response that includes the normalized syndication feed; and
sending the response to the client.

10. The method as recited in claim 9, wherein the request further specifies the particular syndication feed format.

11. The method as recited in claim 9, wherein the particular syndication feed format is determined on the server before the request is received from the client.

12. The method as recited in claim 9, wherein the particular syndication feed format is at least one of RSS version 0.90, RSS version 0.91 Netscape, RSS version 0.91 Userland, RSS version 0.92, RSS version 0.93, RSS version 0.94, RSS version 1.0, RSS version 2.0, Atom version 0.3, or Atom version 1.0.

13. The method as recited in claim 9, wherein the request is formatted as XML or DHTML.

14. The method as recited in claim 9, wherein the source of the syndication feed specified in the request comprises at least one of the URL of the syndication feed or a domain name where one or more syndication feeds are located.

15. The method as recited in claim 9, wherein the request further specifies one or more customization parameters.

16. The method as recited in claim 15, wherein the one or more customization parameters include at least one of:
a parameter specifying the number of headlines to be included in the syndication feed;
a parameter specifying how recent the headlines must be in order to be included in the syndication feed; or
a parameter specifying the type of html tags that can included in the description field of the syndication feed.

17. The method as recited in claim 15, wherein determining whether the syndication feed can be obtained from a cache that is accessible to the server comprises determining whether the syndication feed contained in the cache is capable of being customized according to the one or more customization parameters specified in the request.

18. The method as recited in claim 15, further comprising customizing the syndication feed according to the one or more customization parameters specified in the request.

19. The method as recited in claim 9, wherein determining whether the syndication feed can be obtained from a cache that is accessible to the server comprises determining whether the syndication feed is located at the cache.

20. The method as recited in claim 19, wherein the cache comprises a memory cache and a disk cache, where the memory cache is faster than the disk cache and the disk cache is larger than the memory cache, and determining whether the syndication feed is located at the cache comprises determining whether the memory cache contains the syndication feed, and if the memory cache does not contain the syndication feed, determining whether the disk cache contains the syndication feed.

21. The method as recited in claim 20, wherein retrieving the syndication feed from the source of the syndication feed further comprises:
determining whether the syndication feed retrieved from the source of the syndication feed contains a minimum amount of data; and
placing the syndication feed in the memory cache if the syndication feed retrieved from the source of the syndication feed contains a minimum amount of data.

22. The method as recited in claim 21, wherein placing the syndication feed in the memory cache if the syndication feed retrieved from the source of the syndication feed contains a minimum amount of data comprises storing the syndication feed in at least one of:
the format in which the syndication feed is formatted at the source;
a generic object format;
a normalized format; or
the particular syndication feed format.

23. In a system including at least a server and a client, a method for the server to send a customized syndication feed to the client, the method comprising:
receiving a request for a syndication feed from the client, wherein the request specifies the source of the syndication feed;
determining whether the syndication feed can be obtained from a cache that is accessible to the server;
retrieving the syndication feed from the cache if the syndication feed can be obtained from the cache;
retrieving the syndication feed from the source of the syndication feed if the syndication feed can not be obtained from the cache;
customizing the syndication feed according to one or more customization parameters;
formulating a response that includes the customized syndication feed; and
sending the response to the client.

24. The method as recited in claim 23, wherein the request further specifies the one or more customization parameters.

25. The method as recited in claim 23, wherein the one or more customization parameters are determined on the server before the request is received from the client.

26. The method as recited in claim 23, wherein determining whether the syndication feed can be obtained from a cache that is accessible to the server comprises determining whether the syndication feed contained in the cache is capable of being customized according to the one or more customization parameters.

27. The method as recited in claim 23, wherein customizing the syndication feed according to one or more customization parameters further comprises normalizing the syndication feed into a particular syndication feed format.

28. The method as recited in claim 27, wherein the cache comprises a memory cache and a disk cache, where the memory cache is faster than the disk cache and the disk cache is larger than the memory cache, and determining whether the syndication feed is located at the cache comprises determining whether the memory cache contains the syndication feed, and if the memory cache does not contain the syndication feed, determining whether the disk cache contains the syndication feed.

29. The method as recited in claim 28, wherein retrieving the syndication feed from the source of the syndication feed further comprises:
determining whether the syndication feed retrieved from the source of the syndication feed contains a minimum amount of data; and
placing the syndication feed in the memory cache if the syndication feed retrieved from the source of the syndication feed contains a minimum amount of data.

30. The method as recited in claim 29, wherein placing the syndication feed in the memory cache if the syndication feed retrieved from the source of the syndication feed contains a minimum amount of data comprises storing the syndication feed in at least one of:
the format in which the syndication feed is formatted at the source;
a generic object format;
a normalized format; or
the particular syndication feed format.
